(19) United States
(12) Patent Application Publication
(10) Pub. No.: US 2025/0297891 A1
(43) Pub. Date: Sep. 25, 2025

(54) SENSOR INTEGRATED CIRCUIT FOR SPATIAL LIGHT FLICKER DETECTION

(71) Applicant: Apple Inc., Cupertino, CA (US)

(72) Inventors: Vaibhav Garg, San Jose, CA (US); Shahrooz Shahparnia, Monte Sereno, CA (US)

(21) Appl. No.: 19/074,252

(22) Filed: Mar. 7, 2025

Related U.S. Application Data
(60) Provisional application No. 63/567,842, filed on Mar. 20, 2024.

(51) Int. Cl. G01J 1/36

(52) U.S. Cl. CPC G01J 1/36

(57) ABSTRACT

Apparatuses and methods for flicker detection are described. Some aspects are directed to an optoelectronic device comprising a flicker sensor and a processor. The flicker sensor includes a plurality of photodetectors and readout circuitry. The flicker sensor is configured such that each photodetector of the plurality of photodetectors has a different field of view of a plurality of fields of view. The readout circuitry outputs a digital signal corresponding to a field of view of the plurality of fields of view. The processor of the optoelectronic device is configured to sample the plurality of photodetectors using the readout circuitry, and detect flicker in the one or more of the plurality of fields of view based at least in part on the sampling of the plurality of photodetectors.

### CROSS-REFERENCE TO RELATED APPLICATION(S)

This application is a nonprovisional patent application of and claims the benefit of U.S. Provisional Patent Application No. 63/567,842, filed Mar. 20, 2024 and titled “Sensor Integrated Circuit for Spatial Light Flicker Detection,” the disclosure of which is hereby incorporated herein by reference in its entirety.

### FIELD

The described embodiments relate generally to light flicker detectors and, more particularly, to sensor integrated circuits for spatial light flicker detection.

### BACKGROUND

Cameras continue to be an important feature of consumer electronics devices such as smartphones, tablets, and computers. The imaging capabilities of these consumer electronics devices have steadily increased as individual cameras have improved in quality and devices have started integrating multiple-camera (“multi-camera”) systems and depth sensors, allowing users to capture high quality images in an ever-increasing range of situations. Light sources providing lighting to a scene may introduce flicker having a periodicity. In mixed lighting environments, multiple light sources may flicker at different frequencies (e.g., 120 Hz, 300 Hz, 1 kHz, and so on) in different locations. Additionally, bright light sources that are non-flickering (e.g., the Sun), may also be present. The presence of flickering light sources may negatively impact image capture and degrade the quality of the image. Flicker compensation techniques may be used to mitigate or remove flicker from the captured image. However, the presence of multiple flickering light sources may substantially complicate flicker compensation, rendering current approaches inadequate in some environments. As such, improved flicker sensors are desired.

### SUMMARY

Described herein are sensor integrated circuits for spatial light flicker detection.

Some aspects of this disclosure are directed to an optoelectronic device comprising a flicker sensor and a processor. The flicker sensor includes a plurality of photodetectors and readout circuitry. The flicker sensor is configured such that each photodetector of the plurality of photodetectors has a different field of view of a plurality of fields of view. The readout circuitry outputs a digital signal corresponding to a field of view of the plurality of fields of view. The processor of the optoelectronic device is configured to sample the plurality of photodetectors using the readout circuitry, and detect flicker in the one or more of the plurality of fields of view based at least in part on the sampling of the plurality of photodetectors.

Some aspects of this disclosure are directed to a flicker sensor comprising a plurality of flicker detection photodetectors, a beam shaper, and readout circuitry. Each flicker detection photodetector is configured to receive an optical beam and output an electrical signal. The beam shaper is configured to provide a plurality of fields of view to the plurality of flicker detection photodetectors. Each photodetector of the plurality of flicker detection photodetectors corresponds to one of the plurality of fields of view. The readout circuitry is operatively connected to the plurality of flicker detection photodetectors. For each photodetector, the readout circuitry receives the electrical signal and outputs a digital signal corresponding to a field of view of the plurality of fields of view.

Some aspects of this disclosure are directed to a method of detecting flicker for image capture. The method includes receiving, using a beam shaper configured to provide a plurality of fields of view, an optical beam at a plurality of flicker detection photodetectors. The method further includes sampling, for each field of view of the plurality of fields of view, at least one photodetector of the plurality of flicker detection photodetectors to obtain samples for the field of view. The method also includes detecting flicker in one or more of the plurality of fields of view by analyzing the samples from each field of view of the plurality of fields of view.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a rear view of an illustrative example of a device comprising a flicker sensor as described here. FIG. 1B depicts exemplary components of the device of FIG. 1A.

FIG. 2 shows an example set of fields of view (FoVs) associated with a flicker sensor, according to certain aspects of the present disclosure.

FIG. 3 shows an example of a flicker sensor having multiple FoVs and a single analog frontend (AFE), according to certain aspects of the present disclosure.

FIG. 4 shows an example of a flicker sensor having multiple FoVs and multiple AFEs, according to certain aspects of the present disclosure.

FIG. 5 shows an example of a flicker sensor having multiple FoVs and incorporating a single photodetector sensitive to infrared light, according to certain aspects of the present disclosure.

FIG. 6 shows an example of a flicker sensor having multiple FoVs and incorporating a photodetector sensitive to infrared light for each photodetector sensitive to visible light, according to certain aspects of the present disclosure.

FIG. 7 shows an example of a flicker sensor having multiple FoVs shaped at least in part by a barrier structure, according to certain aspects of the present disclosure.

FIG. 8 shows an example of a flicker sensor having multiple FoVs shaped at least in part by one or more lenses, according to certain aspects of the present disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims. For example, various embodiments are described with regard to a consumer electronics device, such as a smartphone, wearable device (e.g., a head-mounted extended reality (XR) device), hand-held device, computer, or dashboard. However, reference to a consumer electronics device, or a particular type of consumer electronics device, is merely provided for illustrative purposes. The example embodiments may be utilized with, include, or be included in any electronic system, device, or component described herein.

Consumer electronics devices frequently use cameras and camera systems that may operate in complex lighting environments. For example, an indoor environment may present multiple different flickering light sources. The light sources may have different relative intensities, flicker frequencies, and spatial locations. A device with a camera system may attempt to detect these flicker sources, analyze the flicker, and compensate for the flicker in generating an image. Existing techniques that use a single field of view (FoV) for a flicker sensor of a flicker detector may be inadequate in a complex flicker environment. Additionally, non-flickering light sources such as sunlight or candlelight may be present, further complicating detection and compensation for flicker. The presence of the flicker sources may degrade image quality, which may negatively impact the user experience.

Improved techniques for spatial light flicker detection are discussed herein. Various improved apparatuses, including flicker sensors and optoelectronic devices incorporating such flicker sensors, as well as methods of detecting flicker for image capture are described. In some embodiments further described herein, a flicker sensor has multiple different FoVs for photodetectors of the flicker sensor. A beam shaper, such as a barrier device or lens, may be used to shape the FoVs for the flicker structure. In some variations, a barrier device may encircle the various photodetectors of the flicker sensor to shape the FoVs. Additionally or alternatively, a lens, which may include different focusing areas, may be disposed above the photodetectors of the flicker sensor to obtain the various FoVs. Readout circuitry operatively connected to the flicker detection photodetectors receive an electrical signal from each of the photodetectors, and output a digital signal corresponding to a FoV for each of the FoVs. In some embodiments, in addition to photodetectors sensitive to visible light, photodetectors sensitive to infrared light (also referred to herein as infrared photodetectors) may be included in the flicker sensor. Information regarding infrared light levels (whether in a single FoV, or multiple FoVs) can aid in auto-white balance, and localization and exposure algorithms.

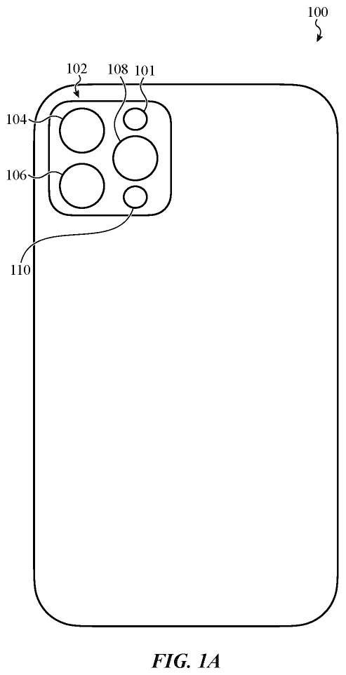

These and other embodiments are discussed below with reference to FIGS. 1A-8. However, those skilled in the art will readily appreciate that the detailed description given herein with respect to these figures is for explanatory purposes only and should not be construed as limiting.

The flicker sensors described herein may be used in any suitable portable electronic device that preferably includes one or more cameras. FIG. 1A shows a rear view of a device 100 suitable for use with the various embodiments of the flicker sensors described here. As shown there, the device 100 comprises a flicker sensor 101 and a multi-camera system 102. While discussed herein as being used with a multi-camera system 102, it should be appreciated that the flicker sensors described herein may be used in the context of a single camera or in any suitable instance where it would be desirable to understand flickering present in a scene. Additionally, while shown as placed on the rear of a device 100, it should be appreciated that a flicker sensor may be additionally or alternatively placed on the front of the device (e.g., a front side having a display) or any other side as desired.

In general, when device 100 includes a multi-camera system 102, the multi-camera system 102 comprises a first camera 104 and a second camera 106. The multi-camera system 102 may optionally include one or more additional cameras, such as a third camera 108. The multi-camera system 102 may further comprise one or more depth sensors (e.g., depth sensor 110).

In some embodiments, the device 100 is an XR device, which may include augmented reality (AR) or virtual reality (VR) devices. In some embodiments, the device 100 is a portable multifunction electronic device, such as a mobile telephone, that also contains other functions, such as PDA and/or music player functions. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer, which may have a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content by transmitting, via a wired or wireless connection, data (e.g., image data or video data) to an integrated or external display generation component to visually produce the content.

FIG. 1B depicts exemplary components of device 100. In some embodiments, device 100 has bus 126 that operatively couples an I/O section 134 with one or more computer processors 136 and memory 138. I/O section 134 can be connected to a display 128, which can have touch-sensitive component 130 and, optionally, intensity sensor 132 (e.g., contact intensity sensor). In addition, I/O section 134 can be connected with communication unit 140 for receiving application and operating system data, using Wi-Fi, Bluetooth, near field communication (NFC), cellular, and/or other wireless communication techniques. Device 100 can include input mechanisms 142 and/or 144. Input mechanism 142 is, optionally, a rotatable input device or a depressible and rotatable input device, for example. Input mechanism 142 is, optionally, a button, in some examples. Device 100 optionally includes various sensors, such as GPS sensor 146, accelerometer 148, directional sensor 150 (e.g., compass), gyroscope 152, motion sensor 154, and/or a combination thereof, all of which can be operatively connected to I/O section 134.

Device 100 includes a camera system 160, which may be an example of a multi-camera system 102. Camera system 160 incudes a flicker sensor 101, further described herein.

Memory 138 of device 100 can include one or more non-transitory computer-readable storage mediums, for storing computer-executable instructions, which, when executed by one or more computer processors 136, for example, can cause the computer processors to perform the techniques that are described here. A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

The processor 136 can include, for example, dedicated hardware as defined herein, a computing device as defined herein, a processor, a microprocessor, a programmable logic array (PLA), a programmable array logic (PAL), a generic array logic (GAL), a complex programmable logic device (CPLD), an application-specific integrated circuit (ASIC), a field-programmable gate array (FPGA), or any other programmable logic device (PLD) configurable to execute an operating system and applications of device 100, as well as to facilitate capturing of images a scene and detecting and compensating for flicker (e.g., using a flicker sensor 101). In some examples, processor 136 may include an image signal processor (ISP) communicatively coupled with the camera system 160 and/or flicker sensor 101. Device 100 is not limited to the components and configuration of FIG. 1B, but can include other or additional components in multiple configurations.

Returning to FIG. 1A, the cameras within a multi-camera system 102 have fields of view that at least partially overlap with each other. In other words, the device 100 may include an additional camera or cameras (not shown) that are not considered part of the multi-camera system 102 if the field(s) of view for the additional camera(s) do not at least partially overlap the field of view of at least one camera within the multi-camera system 102. For example, device 100 may comprise a front-facing camera (not shown) that faces in an opposite direction of the first camera 104 and the second camera 106 (as well as any other cameras of the multi-camera system 102), and thus would not be considered part of the multi-camera system 102.

Similarly, a depth sensor 110 may be considered part of a multi-camera system 102, for example if it is positioned and arranged within device 100 such that the depth sensor 110 is able to obtain depth information at one or more points within a field of view of one or more of the cameras of the multi-camera system 102. The device 100 may comprise one or more depth sensors (e.g., a depth sensor on a front of the device that faces in an opposite direction of the cameras of the multi-camera system 102, and thus are not considered part of the multi-camera system 102. It should be appreciated that a device may include more than one multi-camera systems (e.g., a first multi-camera system on one side of the device and a second multi-camera system on a second side of the device), each of which may optionally comprise a respective depth sensor, and some or all of the multi-camera systems may include a flicker sensor 101 as discussed here.

The cameras of the multi-camera system 102 may have different focal lengths, which may result in the cameras having different field of view sizes.

When device 100 includes a depth sensor 110 associated with a camera or multi-camera system 102, distance information measured by the depth sensor 110 may be used to assist in one or more imaging operations. For example, the depth sensor 110 may be able to provide information about the relative positioning of different objects within a given scene. This information may help in autofocus operations for a camera, or may be used to help determine the illumination profile the adaptive light source module will use to illuminate a given scene. In other words, the depth information may be used as an input in determining the parameters that will be used to control an emitter array (e.g., to select the currents applied to individual emitters or groups of emitters of the emitter array) of the adaptive light source modules described here. For example, in some instances a given emitter of an array may be driven to produce less light to illuminate a target object that is relatively closer to the device 100 than it would to illuminate a target object that is further from the device 100.

The depth sensor 110 may be any suitable system that is capable of calculating the distance between the depth sensor 110 and various points in the scene. The depth sensor 110 may generate a depth map including these calculated distances, which may be used by other systems in the device 100 such as mentioned above. The depth information may be calculated in any suitable manner. In one non-limiting example, a depth sensor may utilize stereo imaging, in which two images are taken from different positions, and the distance (disparity) between corresponding pixels in the two images may be used to calculate depth information. In another example, a depth sensor may utilize structured light imaging, whereby the depth sensor may image a scene while projecting a known pattern (typically using infrared illumination) toward the scene, and then may look at how the pattern is distorted by the scene to calculate depth information. In still another example, a depth sensor may utilize time of flight sensing, which calculates depth based on the amount of time it takes for light (typically infrared) emitted from the depth sensor to return from the scene. A time-of-flight depth sensor may utilize direct time of flight or indirect time of flight, and may illuminate the entire field of coverage 118 at one time, or may only illuminate a subset of the field of coverage 118 at a given time (e.g., via one or more spots, stripes, or other patterns that may either be fixed or may be scanned across the field of coverage 118).

The device 100 may be an optoelectronic device, and include a flicker sensor 101. The flicker sensor 101 may be part of the multi-camera system 102. In some embodiments, the flicker sensor 101 includes a plurality of photodetectors and readout circuitry. The photodetectors of flicker sensor 101 may also be referred to as flicker detection photodetectors herein. The flicker sensor 101 is configured such that each photodetector of the plurality of photodetectors has a different field of view of a plurality of fields of view for flicker sensor 101. The readout circuitry outputs, for example to processor 136 (e.g., an ISP) a digital signal corresponding to a field of view of the plurality of fields of view. The processor 136 of the device 100 is configured to sample the plurality of photodetectors using the readout circuitry, and detect flicker in the one or more of the plurality of fields of view based at least in part on the sampling of the plurality of photodetectors.

Some aspects discussed herein include a method of detecting flicker for image capture, for example performed by a device 100, including the camera system 160 and/or multi-camera system 102, and one or more of processors 136. The method includes receiving, using a beam shaper configured to provide a plurality of fields of view to a plurality of flicker detection photodetectors, an optical beam at a plurality of flicker detection photodetectors. The method further includes sampling, for each field of view, at least one of the flicker detection photodetectors to obtain samples for the field of view. The sampling may be performed by the flicker sensor 101 together with or in response to control signals received from the processor 136. The method also includes detecting flicker in one or more of the plurality of fields of view by analyzing the samples from each field of view. In some embodiments, the analysis and detection of the flicker may be performed by the flicker sensor 101 and/or the processor 136.

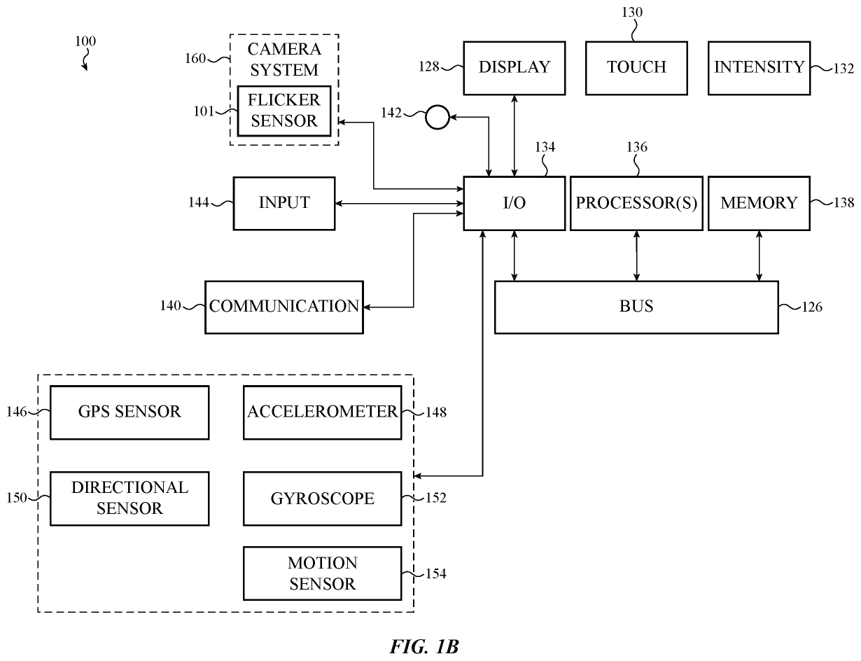

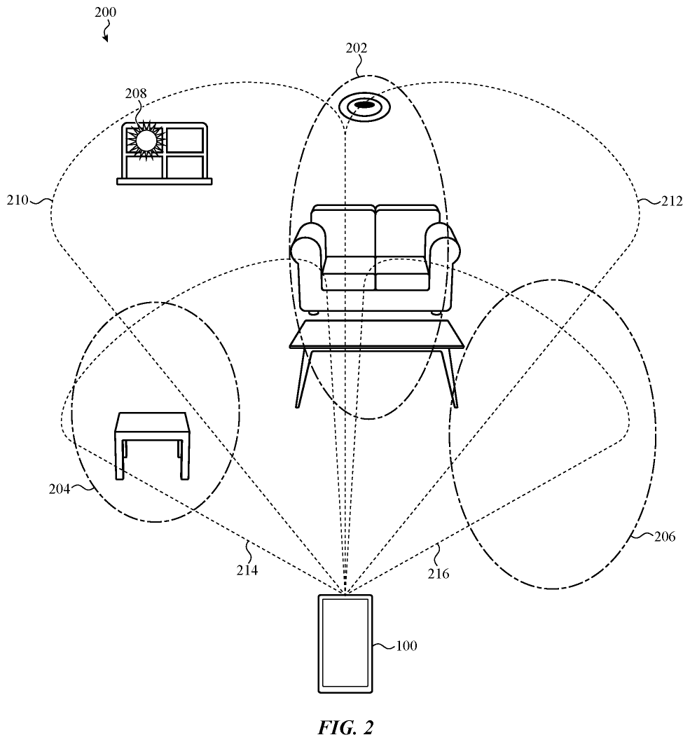

FIG. 2 shows an example set of fields of view 200, according to certain aspects of the present disclosure. A device 100 may, within an overall field of view (FoV) of one or more other components of the device 100, such as a camera (e.g., of multi-camera system 102) observe different sources of light, some of which may flicker. In an example, a first flicker source in an area 202 may be an overhead light flickering with a frequency of 120 Hz. A second flicker source in an area 204 may be flickering with a frequency of 1 kHz. A third flicker source in an area 206 may be flickering with a frequency of 300 Hz. A fourth source of light 208 may be constant (non-flickering), such as sunlight.

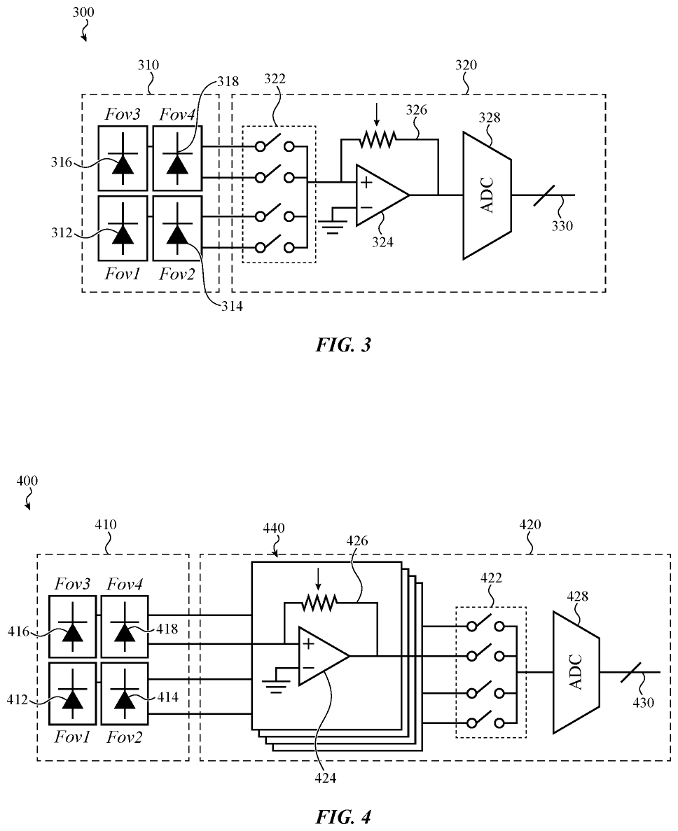

Generally, a flicker sensor of device 100 may use an array of photodiodes (e.g., a 2×2 array in an example embodiment) to create multiple fields of views to divide the scene into multiple flicker detection zones. For example, set of fields of view 200 can include four FoVs: a first FoV 210, a second FoV 212, a third FoV 214, and a fourth FoV 216. As further described herein, the multiple FoVs of the set of fields of view 200 can be achieved via a lens or vertical barriers within the flicker sensor of the device 100. The first FoV 210, the second FoV 212, the third FoV 214, and the fourth FoV 216 may be examples of FoV1, FoV2, FoV3, and FoV4 further described herein with reference to any of FIGS. 3-8. Although four FoVs are described, other quantities of FoV (e.g., two or more FoV) may be used consistent with the techniques and designs described herein.

For each zone, flicker information can be obtained independently allowing an image signal processor (ISP) of device 100 to figure out relatively weaker versus relatively stronger flicker areas, as well as local versus global flicker. Based on a FoV or zoom of a camera or a user's gaze, appropriate flicker mitigation can be selected to minimize the impact of flicker on the user experience.

FIG. 3 shows an example of a flicker sensor 300 having multiple FoVs and a single analog frontend (AFE), according to certain aspects of the present disclosure. In some embodiments, the flicker sensor 300 may be an example of the flicker sensor 101. Flicker sensor 300 includes a photodetector portion 310 and readout circuitry 320. Generally, flicker sensor 300 illustrates an embodiment where the photodetectors (e.g., photodiodes) are multiplexed into one AFE, and then digitized via an analog-to-digital converter (ADC) for further signal processing of each FoV. In some embodiments, the flicker sensor 300 may optimize (e.g., result in a relatively lower) area and power consumption. In some embodiments, the flicker sensor 300 may have a relatively longer delay in sampling for each FoV than a flicker sensor design that uses more than one AFE (e.g., one AFE for each photodetector). As used herein, an “AFE” refers to the circuits between the photodetectors and the ADC. In the context of the flicker sensor 300, the AFE includes at least the amplifier 324 and variable resister 326 of the readout circuitry 320, and may also include multiplexer 322. As such, the FoVs of flicker sensor 300 may be associated with a single AFE.

The photodetector portion 310 includes a set of photodetectors that each have a different FoV. In the examples of flicker sensor 300, four photodetectors each have a corresponding FoV: photodetector 312 has a corresponding FoV1; photodetector 314 has a corresponding FoV2; photodetector 316 has a corresponding FoV3; and photodetector 318 has a corresponding FoV4. In some examples, first FoV 210, second FoV 212, third FoV 214, and fourth FoV 216 may be examples of FoV1, FoV2, FoV3, and FoV4 associated with flicker sensor 300.

Each of the photodetector 312, photodetector 314, photodetector 316, and photodetector 318 are illustrated as photodiodes. In some embodiments, photodetector 312, photodetector 314, photodetector 316, and photodetector 318 are silicon photodiodes. In other embodiments, any semiconductor device that outputs an electrical current (which may also be broadly referred to as an electrical signal) responsive to light via the photoelectric effect may be used. In other embodiments, one or more other transducer devices that provide an electrical signal (e.g., voltage or current signal) responsive to at least visible light may be used, for example using different semiconductor materials and/or structures.

The electrical output (e.g., a current output) of each photodetector of the photodetector portion 310 is input to a multiplexer 322 of the readout circuitry 320. The multiplexer 322 may be controlled by the readout circuitry 320 itself, or switched by a processor (e.g., an image signal processor (ISP)), to cause the multiplexer 322 to selectively output the current generated by one of the photodetector 312, photodetector 314, photodetector 316, or photodetector 318.

The output of the multiplexer 322 is provided to an amplifier 324. In one or more embodiments, the amplifier 324 is a transimpedance amplifier implemented with an operational amplifier that uses an adjustable feedback resistor, the variable resistor 326, that couples the output of the operational amplifier to a first input of the operational amplifier. The second input of the operational amplifier may be tied to ground.

In one or more embodiments, the gain of the amplifier 324 may be controlled via the variable resistor 326. The value of the variable resistor 326 may be controlled (e.g., set) by the readout circuitry 320 itself, or via a processor (e.g., an ISP). In some embodiments, the variable resistor 326 may be adjusted up (relatively higher resistance value) or down (relatively lower resistance value) to increase the gain or decrease the gain of the amplifier 324 in response to lower light conditions or brighter light conditions, respectively.

In other embodiments, the amplifier 324 may be a capacitive transimpedance amplifier (e.g., where one or more capacitors are provided between the output and the first input of the operational amplifier). In some cases, the illustrated version of the amplifier 324 may provide faster operation than a capacitive transimpedance amplifier.

The output of the amplifier 324 is provided to an analog-to-digital converter 328. The analog-to-digital converter 328 may be any suitable analog-to-digital converter to convert the input analog signal to a digital output signal 330. The digital output signal 330 may have a quantity of levels (e.g., bits, such as 8 bits, 12 bits, or 16 bits) selected to effectively detect flicker in the corresponding FoV without overly increasing cost or complexity. The digital output signal 330 may be output from the readout circuitry 420, for example to a processor (e.g., an ISP).

FIG. 4 shows an example of a flicker sensor 400 having multiple FoVs and multiple AFEs, according to certain aspects of the present disclosure. In some embodiments, the flicker sensor 400 may be an example of the flicker sensor 101. Flicker sensor 400 includes a photodetector portion 410 and readout circuitry 420. Generally, flicker sensor 400 illustrates an embodiment where each of the photodetectors (e.g., photodiodes) has its own corresponding AFE and is then multiplexed and digitized via ADC. In some embodiments, the flicker sensor 400 may prioritize (e.g., relative to flicker sensor 300) faster conversion of the flicker signal, but using a relatively greater area and power consumption. In the context of the flicker sensor 400, the AFE for a particular photodetector includes at least the amplifier 424 and variable resister 426 of the readout circuitry 420, and may also include multiplexer 422. For example, the AFE for photodetector 418 (a first AFE associated with FoV4) includes a first amplifier and variable resistor of the set of amplifiers 440 (e.g., amplifier 424 and variable resister 426), and the AFE for photodetector 416 (a second AFE associated with FoV3) includes a second amplifier and variable resistor of the set of amplifiers 440 (not shown). As such, the four FoVs of flicker sensor 400 may be associated with four respective AFEs.

The photodetector portion 410 includes a set of photodetectors that each have a different FoV. In the examples of flicker sensor 400, four photodetectors each have a corresponding FoV: photodetector 412 has a corresponding FoV1; photodetector 414 has a corresponding FoV2; photodetector 416 has a corresponding FoV3; and photodetector 418 has a corresponding FoV4. In some examples, first FoV 210, second FoV 212, third FoV 214, and fourth FoV 216 may be examples of FoV1, FoV2, FoV3, and FoV4 associated with flicker sensor 400.

The photodetector portion 410 may be an example of or include one or more aspects of the photodetector portion 310. For example, each of the photodetector 412, photodetector 414, photodetector 416, and photodetector 418 may be examples of photodetector 312, photodetector 314, photodetector 316, or photodetector 318, respectively.

The electrical output (e.g., a current output) of each photodetector of the photodetector portion 410 is separately input a respective an amplifier 424 of the set of amplifiers 440 of the readout circuitry 420. The set of amplifiers 440 and multiplexer 422 may also be collectively referred to as a set of AFEs for the set of photodetectors and associated FoVs. Each amplifier 424 uses an adjustable feedback resistor, the variable resistor 426. Each amplifier 424 of the set of amplifiers 440 may be an example of or include one or more aspects of the amplifier 324. Similarly, each variable resistor 426 may be an example of or include one or more aspects of the variable resistor 326.

As such, for a set of four photodetectors within photodetector portion 410, four of the variable resistor 426 may be controllable to change the gain of each corresponding amplifier 424 of the set of amplifiers 440. The value of each variable resistor 426 may be controlled (e.g., set) by the readout circuitry 420 itself, or via a processor (e.g., an ISP). In some embodiments, each variable resistor 426 may be individually adjusted up (relatively higher resistance value) or down (relatively lower resistance value) to increase the gain or decrease the gain of a corresponding amplifier 424 in response to lower light conditions or brighter light conditions, respectively. For example, the gain may be increased for the amplifier 424 corresponding to photodetector 418 based on a relatively lower (e.g., dimmer) light condition in FoV4, and the gain may be decreased for the amplifier 424 corresponding to photodetector 416 based on a relatively higher (e.g., brighter) light condition in FoV3.

The output of each amplifier 424 of the set of amplifiers 440 is provided to a respective input of a multiplexer 422 of the readout circuitry 420. The multiplexer 422 may be controlled by the readout circuitry 420 itself, or switched by a processor (e.g., an ISP), to cause the multiplexer 422 to selectively output the amplified voltage output generated by each amplifier 424 of the set of amplifiers 440.

The selected output of the multiplexer 422 is provided to an analog-to-digital converter 428, which outputs the digital output signal 430. The analog-to-digital converter 428 may be an example of or include one or more aspects of the analog-to-digital converter 328. The digital output signal 430 may be output from the readout circuitry 420, for example to a processor (e.g., an ISP).

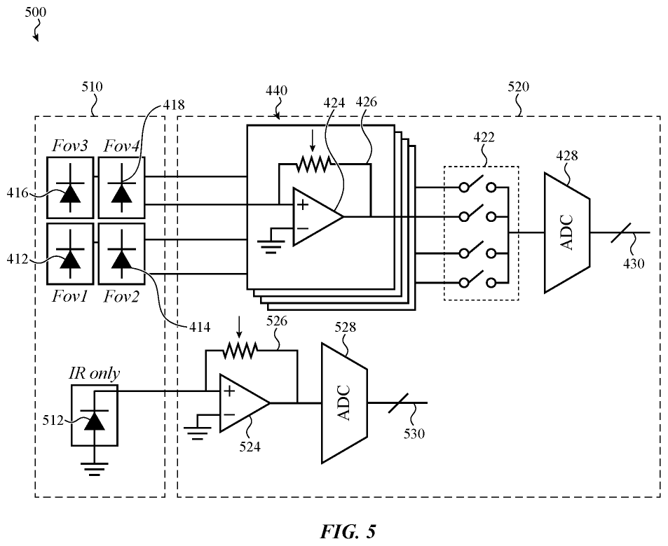

FIG. 5 shows an example of a flicker sensor 500 having multiple FoVs and incorporating a single photodetector sensitive to infrared light, according to certain aspects of the present disclosure. In some embodiments, the flicker sensor 500 may be an example of the flicker sensor 101. In addition, generally, flicker sensor 500 illustrates an embodiment where a second channel sensitive to infrared light can be added to detect and measure infrared signals present in the incident light. In some examples, this information can be used in aiding auto-white balance, localization, and exposure algorithms.

Flicker sensor 500 includes a photodetector portion 510 and readout circuitry 520. Flicker sensor 500 includes aspects of flicker sensor 400, for example the photodetector portion 410 and readout circuitry 420. In addition to photodiodes sensitive to at least visible light (e.g., photodetector 412, photodetector 414, photodetector 416, and photodetector 418), a photodetector portion 510 may include a photodetector 512 that is sensitive to infrared light. In some embodiments, the photodetector 512 is sensitive to at least infrared light. In some embodiments, photodetector 512 is sensitive to only infrared light (e.g., substantially sensitive only to infrared light, to the exclusion of sensitivity to visible light). In yet other embodiments, photodetector 512 is sensitive to selected wavelengths or sets of wavelengths of infrared light (e.g., near-infrared, mid-infrared, far-infrared, etc.). As used herein, infrared light generally refers to wavelengths of light from about 750 nm to about 1,000 μm. Visible light generally refers to wavelengths of light from about 400 nm to about 700 μm. As used herein, a photodetector may be sensitive to a particular wavelength or set of wavelengths of light while being sensitive to, at least in part, other wavelengths or sets of wavelengths of light.

For flicker sensor 500, the photodetector 512 outputs an electrical signal (a current) to amplifier 524. Similar to the photodetectors sensitive to visible light, amplifier 524 uses an adjustable feedback resistor, the variable resistor 526. The FoV associated with the photodetector 512 (FoV_{IR}) may be different than each of the FoVs associated with the photodetectors sensitive to visible light (FoV1, FoV2, FoV3, and FoV4). In some embodiments, the FoV_{IR} substantially includes each of FoV1, FoV2, FoV3, and FoV4, and is about the same as a combination of FoV1, FoV2, FoV3, and FoV4. In other embodiments, the FoV_{IR} is larger (broader) than the combination of FoV1, FoV2, FoV3, and FoV4. In yet embodiments, the FoV_{IR} is smaller (narrower) than the combination of FoV1, FoV2, FoV3, and FoV4.

The variable resistor 526 may be adjusted up (relatively higher resistance value) or down (relatively lower resistance value) to increase the gain or decrease the gain of the amplifier 524 in response to lower light conditions or brighter light conditions, respectively. The output of the amplifier 524 is provided to an analog-to-digital converter 528, which outputs the digital output signal 530. The analog-to-digital converter 528 may be an example of or include one or more aspects of the analog-to-digital converter 328 or analog-to-digital converter 428. The digital output signal 530 (and the digital output signal 430) may be output from the readout circuitry 520, for example to a processor (e.g., an ISP). In some examples, the AFE for the photodetector 512 sensitive to infrared light refers to the amplifier 524 and the variable resistor 526, and may be a fifth AFE in addition to the four AFEs associated with the photodetectors sensitive to visible light (photodetector 412, photodetector 414, photodetector 416, and photodetector 418).

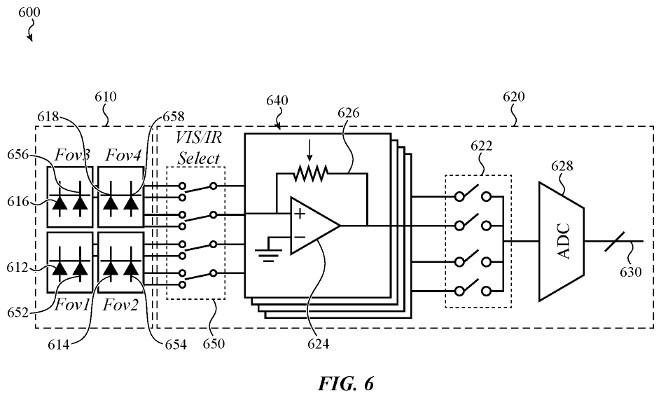

FIG. 6 shows an example of a flicker sensor 600 having multiple FoVs and incorporating a photodetector sensitive to infrared light for each photodetector sensitive to visible light, according to certain aspects of the present disclosure. In some embodiments, the flicker sensor 600 may be an example of the flicker sensor 101. Flicker sensor 600 includes a photodetector portion 610 and readout circuitry 620. Generally, flicker sensor 600 illustrates an embodiment where a photodiode sensitive to infrared light is added to each of the field-of-view zones. The clear/visible light channel and infrared channel are selected between, and the selected channel converted by the subsequent AFE and ADC. In the example, of the flicker sensor 600, four AFEs are shown, one AFE for each FoV associated with a visible light-infrared light photodetector pair. In some embodiments, the flicker sensor 600 can provide spatially localized information about infrared light sources (e.g., more spatially localized relative to the flicker sensor 500), such as sunlight from a window, and inform a camera and/or image processing algorithms.

The photodetector portion 610 includes a set of photodetectors that each have a different FoV. In the examples of flicker sensor 600, the photodetector portion 610 includes four photodetectors sensitive to visible light (photodetector 612, photodetector 614, photodetector 616, and photodetector 618) and four photodetectors sensitive to infrared light (photodetector 652, photodetector 654, photodetector 656, and photodetector 658), arranged in pairs for a corresponding FoV. The pair including the photodetector 612 and photodetector 652 have a corresponding FoV1; the pair including the photodetector 614 and photodetector 654 have a corresponding FoV2; the pair including the photodetector 616 and photodetector 656 have a corresponding FoV3; and the pair including the photodetector 618 and photodetector 658 have a corresponding FoV4. In some examples, first FoV 210, second FoV 212, third FoV 214, and fourth FoV 216 may be examples of FoV1, FoV2, FoV3, and FoV4 associated with flicker sensor 600.

The readout circuitry 620 includes a multiplexer 650 to select between visible light photodetectors and infrared light photodetectors. In some embodiments, the multiplexer 650 has eight inputs and four inputs. The multiplexer 650 may be alternatively configured (e.g., as four 2:1 multiplexers, two 4:2 multiplexers), for example where an input for each current output from photodetectors of the photodetector portion 610 are selectively able to be provided to an amplifier of the readout circuitry.

The electrical output (e.g., a current output) of each pair of photodetectors (either one of the visible light photodetector or infrared light photodetector of the pair as selected by the multiplexer 650) of the photodetector portion 610 is separately input to a respective amplifier 624 of the set of amplifiers 640 of the readout circuitry 620. Each amplifier 624 uses an adjustable feedback resistor, the variable resistor 626. Each amplifier 624 of the set of amplifiers 640 may be an example of or include one or more aspects of the amplifier 324, amplifier 424, or amplifier 524. Similarly, each variable resistor 626 may be an example of or include one or more aspects of the variable resistor 326, variable resistor 426, or variable resistor 526.

The output of each amplifier 624 of the set of amplifiers 640 is provided to a respective input of a multiplexer 622 of the readout circuitry 620. The multiplexer 622 may be controlled by the readout circuitry 620 itself, or switched by a processor (e.g., an ISP), to cause the multiplexer 622 to selectively output the amplified voltage output generated by each amplifier 624 of the set of amplifiers 640.

The selected output of the multiplexer 622 is provided to an analog-to-digital converter 628, which outputs the digital output signal 630. The analog-to-digital converter 628 may be an example of or include one or more aspects of the analog-to-digital converter 328, the analog-to-digital converter 428, or the analog-to-digital converter 528. The digital output signal 630 may be output from the readout circuitry 620, for example to a processor (e.g., an ISP).

In one or more embodiments, the multiplexer 650 and the multiplexer 622 may be collectively controlled by the readout circuitry 620 itself, or switched by a processor (e.g., an ISP), to cause the multiplexer 622 to selectively output the amplified voltage output generated by each amplifier 624 of the set of amplifiers 640 to the analog-to-digital converter 628.

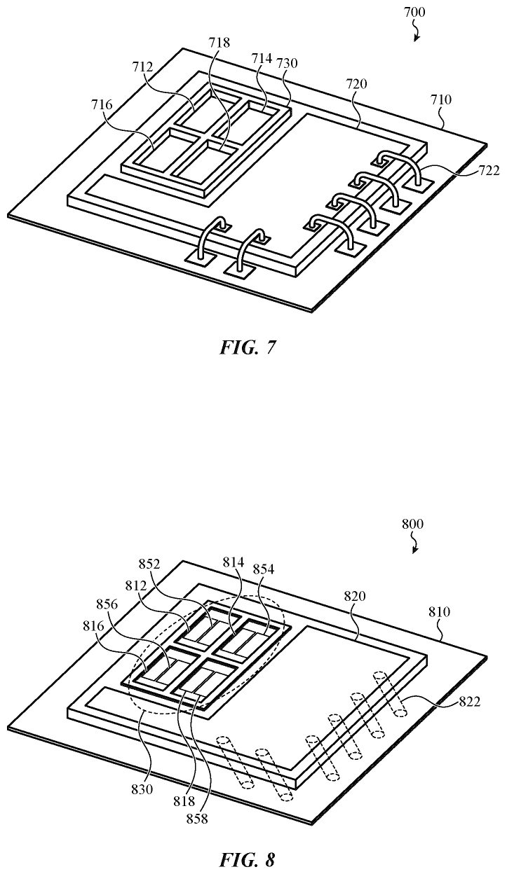

FIG. 7 shows an example of a flicker sensor 700 having multiple FoVs shaped at least in part by a barrier structure, according to certain aspects of the present disclosure. In some embodiments, the flicker sensor 700 may be an example of the flicker sensor 101. In some embodiments, the flicker sensor 700 may be an example of or include one or more aspects of flicker sensor 300 or flicker sensor 400, portions of flicker sensor 500 (e.g., where the photodetector sensitive to infrared light is not shown), or portions of flicker sensor 600 (e.g., where the photodetector sensitive to infrared light is not shown).

Flicker sensor 700 includes readout circuitry 720 and a set of photodetectors in a photodetector portion. The set of photodetectors may include photodetector 712, photodetector 714, photodetector 716, and photodetector 718. In one or more embodiments, each of the readout circuitry 720 and the set of photodetectors are formed on a substrate, such as a semiconductor substrate (e.g., a silicon substrate). The readout circuitry 720 may be an example of or include one or more aspects of any of readout circuitry 320, readout circuitry 420, readout circuitry 520, or readout circuitry 620.

In some embodiments, the substrate may be mounted (affixed, bonded, soldered) to a printed circuit board 710. In some examples, electrical signals may be obtained from or provided to the readout circuitry 720 via a set of wired interconnect.

Generally, flicker sensor 700 illustrates down-bonding from the substrate to the printed circuit board 710, using interconnect 722 (e.g., wires). For examples, because there may need to be an opening for light to reach each of the photodetectors (photodetector 712, photodetector 714, photodetector 716, and photodetector 718), the substrate (which may be silicon) may not be able to be flipped to create a standard wafer level scale package with bumps to minimize footprint. As such, the flicker sensor 700 can be to use pads on a bare silicon die which are down-bonded to the pads on the printed circuit board 710 by a module manufacturer and then the whole module may be covered with protective glue.

The flicker sensor 700 also includes a vertical barrier structure 730 encircling the set of photodetectors. In one or more embodiments the vertical barrier structure 730 is an example of a beam shaper. In some embodiments, the vertical barrier structure 730 encircles each individual photodetector of the set of photodetectors. For example, in an example of four photodetectors (photodetector 712, photodetector 714, photodetector 716, and photodetector 718), each photodetector may be encircled, such that the vertical barrier structure 730 encloses four regions, each region providing a different field of view for each of the photodetectors. For example, photodetector 712 may be encircled by at least a first portion of the vertical barrier structure 730, which provided a first field of view to the photodetector 712 that is different from a second field of view provided by a second portion of the vertical barrier structure 730 that encircles the photodetector 714.

In some embodiments, the vertical barrier structure 730 may be grown on the substrate (e.g., a silicon substrate). Although described as “vertical,” the walls of the vertical barrier structure 730 may form a barrier that generally extends vertically away from the photodetectors. However, the walls of the vertical barrier structure 730 need not be perpendicular to the photodetectors (e.g., vertically oriented). In particular, the walls of the vertical barrier structure 730 may be shaped and angled to provide the desired field of view for each of the respective photodetectors of the set of photodetectors. Additionally, the walls of the vertical barrier structure 730 need not form a square or rectangle structure (e.g., when viewed in a top view) as illustrated for the flicker sensor 700, and instead may be generally round, oval, or any suitable shape or structure to provide the desired fields of view to the photodetectors (e.g., set of fields of view 200). In some examples, various patterning techniques may be used to form the vertical barrier structure 730.

In other embodiments, the vertical barrier structure 730 may be a separately formed structure that is bonded to or otherwise affixed to the substrate on which the set of photodetectors are formed.

FIG. 8 shows an example of a flicker sensor 800 having multiple FoVs shaped at least in part by one or more lenses, according to certain aspects of the present disclosure. In some embodiments, the flicker sensor 800 may be an example of the flicker sensor 101. In some embodiments, the flicker sensor 700 may be an example of or include one or more aspects of flicker sensor 600, or portions of flicker sensor 400, flicker sensor 500, or flicker sensor 600 (e.g., but including photodetectors sensitive to infrared light along with photodetectors sensitive to infrared light).

Generally, flicker sensor 800 illustrates an embodiment that includes building through-silicon vias (TSVs) on the silicon substrate integrated circuit. Additionally, the flicker sensor 800 shows both visible and infrared sensitive photodetectors (e.g., photodiodes) a formed on a silicon substrate, and each pair of visible and infrared sensitive photodetectors share a common FoV. In some embodiments, each of the photodetectors (including both visible and infrared sensitive photodetectors) have their own, respective, FoV. In other embodiments, a different combination of visible and infrared sensitive photodetectors can be used. Additionally, or alternatively to a physical barrier on silicon, an optical lens or system of optical lenses can be used to create each FoV.

Flicker sensor 800 includes readout circuitry 820 and a set of photodetectors in a photodetector portion. The set of photodetectors may include both photodetectors sensitive to visible light (e.g., photodetector 812, photodetector 814, photodetector 816, and photodetector 818) as well as photodetectors sensitive to infrared light (e.g., photodetector 852, photodetector 854, photodetector 856, and photodetector 858). In one or more embodiments, each of the readout circuitry 820 and the set of photodetectors are formed on a substrate, such as a semiconductor substrate (e.g., a silicon substrate). The readout circuitry 820 may be an example of or include one or more aspects of any of readout circuitry 320, readout circuitry 420, readout circuitry 520, or readout circuitry 620.

In some embodiments, the substrate may have formed therein TSVs 822. The TSVs 822 may connect to bumps on the bottom of the substrate (e.g., an integrated circuit (IC)). In one or more embodiments, the substrate is an IC substrate that is packaged using wafer level chip scale package (WLCSP) techniques, for example using clear epoxy by a silicon manufacturer. In some cases, the use of TSVs 822 leads to reducing the overall footprint on the PCB 810, and result in significant area savings, for example relative to mounting techniques described with reference to the flicker sensor 700.

As further described herein, the flicker sensor 800 may additionally include, or be associated with, an optical lens 830 to provide the FoV of the set of FoVs to each respective photodetector pair (e.g., one such pair being photodetector 812 and photodetector 852). In some embodiments, the optical lens 830 may have different regions or areas that provide the FoV to a photodetector pair. In one embodiment, the optical lens 830 may have four areas (four lenses or sub-lenses) to provide four FoVs corresponding to the four pairs of photodetectors. For example, one region of optical lens 830 may provide a first FoV for the pair of photodetector 812 and photodetector 852 (e.g., generally above the photodetector 812 and photodetector 852). In some embodiments, the lens uses metasurfaces to form and shape the desired FoVs.

Some aspects of this disclosure are directed to a method of detecting flicker for image capture. The method may be performed by a device 100 as further described herein, using one or more of flicker sensor 101, multi-camera system 102, processor 136, flicker sensor 300, flicker sensor 400, flicker sensor 500, flicker sensor 600, flicker sensor 700, or flicker sensor 800, or aspects of these devices.

In some embodiments, the method includes receiving, using a beam shaper configured to provide a plurality of fields of view, an optical beam at a plurality of flicker detection photodetectors. The method further includes sampling, for each field of view of the plurality of fields of view, at least one photodetector of the plurality of flicker detection photodetectors to obtain samples for the field of view. The method also includes detecting flicker in one or more of the plurality of fields of view by analyzing the samples from each field of view of the plurality of fields of view.

In some embodiments, sampling the at least one photodetector of the plurality of flicker detection photodetectors comprises switching a multiplexer to sequentially receive an output of each photodetector of the plurality of flicker detection photodetectors, an output of the multiplexer coupled with an amplifier and an analog-to-digital converter.

In some embodiments, sampling the at least one photodetector of the plurality of flicker detection photodetectors comprises switching a multiplexer to sequentially receive, for each amplifier of a plurality of amplifiers, an output of the amplifier, wherein an input of the amplifier is coupled with an output of one of the plurality of flicker detection photodetectors, and an output of the multiplexer is coupled with an analog-to-digital converter.

In one or more embodiments, the method further includes receiving, using the beam shaper, the optical beam at one or more photodetectors sensitive to infrared light; sampling the one or more photodetectors sensitive to infrared light to obtain infrared signal information; and adjusting one or more an auto-white balance, a localization algorithm, or an exposure algorithm based at least in part on the infrared signal information.

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof.

Additionally, directional terminology, such as “top”, “bottom”, “upper”, “lower”, “front”, “back”, “over”, “under”, “above”, “below”, “left”, “right”, etc. is used with reference to the orientation of some of the components in some of the figures described below. Because components in various embodiments can be positioned in a number of different orientations, directional terminology is used for purposes of illustration only and is in no way limiting. The directional terminology is intended to be construed broadly, and therefore should not be interpreted to preclude components being oriented in different ways. These words are intended to relate to the equivalent direction as depicted in a reference illustration; as understood contextually from the object(s) or element(s) being referenced, such as from a commonly used position for the object(s) or element(s); or as otherwise described herein. Further, it is noted that the term “signal” means a waveform (e.g., electrical, optical, magnetic, mechanical, or electromagnetic) capable of traveling through a medium such as DC, AC, sinusoidal-wave, triangular-wave, square-wave, vibration, and the like.

Also, as used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

Although the disclosed embodiments have been illustrated and described with respect to one or more implementations, equivalent alterations and modifications will occur or be known to others skilled in the art upon the reading and understanding of this specification and the annexed drawings. In addition, while a particular feature is disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above-described embodiments. Rather, the scope of the disclosure should be defined in accordance with the following claims and their equivalents.

1. An optoelectronic device, comprising:
a flicker sensor comprising:
a plurality of photodetectors, wherein the flicker sensor is configured such that each photodetector of the plurality of photodetectors has a different field of view of a plurality of fields of view; and
readout circuitry to output a digital signal corresponding to a field of view of the plurality of fields of view; and
a processor configured to:
sample the plurality of photodetectors using the readout circuitry; and
detect flicker in the one or more of the plurality of fields of view based at least in part on the sampling of the plurality of photodetectors.

2. The optoelectronic device of claim 1, further comprising:
at least one lens configured to, for each field of view of the plurality of fields of view, direct at least a portion of an optical beam toward one of the plurality of photodetectors.

3. The optoelectronic device of claim 1, further comprising:
a vertical barrier structure encircling the plurality of photodetectors.

4. The optoelectronic device of claim 1, wherein:
the plurality of photodetectors are sensitive to at least visible light; and
the flicker sensor further comprises one or more photodetectors sensitive to infrared light.

5. The optoelectronic device of claim 4, wherein the one or more photodetectors sensitive to infrared light comprise a single photodetector.

6. The optoelectronic device of claim 4, wherein the one or more photodetectors sensitive to infrared light comprise a plurality of photodetectors sensitive to infrared light, and the flicker sensor is further configured to provide the plurality of fields of view to the plurality of photodetectors sensitive to infrared light.

7. The optoelectronic device of claim 4, wherein the flicker sensor is further configured such that at least one of the one or more photodetectors sensitive to infrared light has a different field of view than the plurality of fields of view.

8. The optoelectronic device of claim 1, wherein the readout circuitry further comprises a multiplexer configured to receive an electrical signal from each photodetector of the plurality of photodetectors, and to selectively output the electrical signal from one of the plurality of photodetectors to an amplifier and provide an output of the amplifier to an analog-to-digital converter that outputs the digital signal.

9. The optoelectronic device of claim 1, wherein the readout circuitry further comprises a plurality of amplifiers, wherein, for each photodetector of the plurality of photodetectors, an amplifier of the plurality of amplifiers is configured to receive an electrical signal from the photodetector and provide an output of the amplifier to a multiplexer, the multiplexer selectively providing an output corresponding to one of the plurality of photodetectors to an analog-to-digital converter that outputs the digital signal.

10. A flicker sensor, comprising:
a plurality of flicker detection photodetectors, each flicker detection photodetector configured to receive an optical beam and output an electrical signal;
a beam shaper configured to provide a plurality of fields of view to the plurality of flicker detection photodetectors, each photodetector of the plurality of flicker detection photodetectors corresponding to one of the plurality of fields of view; and
readout circuitry operatively connected to the plurality of flicker detection photodetectors to, for each photodetector, receive the electrical signal and output a digital signal corresponding to a field of view of the plurality of fields of view.

11. The flicker sensor of claim 10, wherein the beam shaper comprises at least one lens configured to, for each field of view of the plurality of fields of view, direct at least a portion of an optical beam toward one of the plurality of flicker detection photodetectors.

12. The flicker sensor of claim 10, wherein the beam shaper comprises a vertical barrier structure encircling the plurality of flicker detection photodetectors.

13. The flicker sensor of claim 10, wherein:
the plurality of flicker detection photodetectors are sensitive to at least visible light; and
the flicker sensor further comprises one or more photodetectors sensitive to infrared light.

14. The flicker sensor of claim 13, wherein the one or more photodetectors sensitive to infrared light comprise a single photodetector.

15. The flicker sensor of claim 13, wherein the one or more photodetectors sensitive to infrared light comprise a plurality of photodetectors sensitive to infrared light, and the beam shaper is further configured to provide the plurality of fields of view to the plurality of infrared photodetectors.

16. The flicker sensor of claim 13, wherein the beam shaper is further configured such that at least one of the one or more photodetectors sensitive to infrared light has a different field of view than the plurality of fields of view.

17. A method of detecting flicker for image capture, comprising:
receiving, using a beam shaper configured to provide a plurality of fields of view, an optical beam at a plurality of flicker detection photodetectors;
sampling, for each field of view of the plurality of fields of view, at least one photodetector of the plurality of flicker detection photodetectors to obtain samples for the field of view; and
detecting flicker in one or more of the plurality of fields of view by analyzing the samples from each field of view of the plurality of fields of view.

18. The method of claim 17, wherein sampling the at least one photodetector of the plurality of flicker detection photodetectors comprises:
switching a multiplexer to sequentially receive an output of each photodetector of the plurality of flicker detection photodetectors, an output of the multiplexer coupled with an amplifier and an analog-to-digital converter.

19. The method of claim 17, wherein sampling the at least one photodetector of the plurality of flicker detection photodetectors comprises:
switching a multiplexer to sequentially receive, for each amplifier of a plurality of amplifiers, an output of the amplifier, wherein an input of the amplifier is coupled with an output of one of the plurality of flicker detection photodetectors, and an output of the multiplexer is coupled with an analog-to-digital converter.

20. The method of claim 17, further comprising:
receiving, using the beam shaper, the optical beam at one or more photodetectors sensitive to infrared light;
sampling the one or more photodetectors sensitive to infrared light to obtain infrared signal information; and
adjusting one or more an auto-white balance, a localization algorithm, or an exposure algorithm based at least in part on the infrared signal information.
